(19) United States
(12) Patent Application Publication
(10) Pub. No.: US 2012/0301137 A1
(43) Pub. Date: Nov. 29, 2012

(54) ERRONEOUS OPTICAL FIBER CONNECTION DETECTING METHOD AND NODE DEVICE

(75) Inventor: Takeshi SAKAMOTO, Kawasaki (JP)

(73) Assignee: FUJITSU LIMITED, Kawasaki-shi (JP)

(21) Appl. No.: 13/434,758

(22) Filed: Mar. 29, 2012

(30) Foreign Application Priority Data
May 23, 2011 (JP) 2011-114650

(51) Int. Cl. H04B 10/08

(52) U.S. Cl. 398/16; 398/34

(57) ABSTRACT

A node device includes a data pattern generator configured to generate different fixed patterns for a plurality of ports to insert the generated fixed patterns into optical signals output from a plurality of optical transmitters, an optical switch configured to switch outgoing paths of the optical signals to output the optical signals as a multiplexed signal from one of the ports, a detector configured to detect a frequency spectrum of the multiplexed optical signal, and a management part configured to monitor a peak frequency of the detected frequency spectrum to detect an erroneous optical fiber connection associated with the optical transmitters based on peak frequencies corresponding to the different fixed patterns for the respective ports.

### CROSS-REFERENCE TO RELATED APPLICATION

This patent application is based upon, and claims the benefit of priority of Japanese Patent Application No. 2011-114650 filed on May 23, 2011, the entire contents of which are incorporated herein by reference.

### FIELD

The embodiments discussed herein are related to an erroneous optical fiber connection detecting method and a node device.

### BACKGROUND

A CDC system composed of nodes having a colorless, directionless and contentionless function (hereinafter called a “CDC” function) utilizing a wavelength selected switch (WSS) or an optical cross connect switch (N×N_OXC) has been proposed for improving flexibility of an optical wavelength or outgoing path of a wavelength division multiplexer (WDM) signal in a wave length multiplexing system. Note that the “colorless” indicates capability of flexibly changing a wavelength of an output light, the “directionless” indicates capability of flexibly changing an outgoing path of the output light, and the “contentionless” indicates capability of preventing collision (interference) between wavelengths of the output light.

In a node implementing such a CDC function, an optical device of a smallest possible unit is accommodated in a package and an optical fiber is connected between those packages in order to secure modularity.

FIG. 1 illustrates a configuration diagram of a related art node device having a CDC function. In FIG. 1, an optical transmitter-receiver part 1-1 receives an optical multiplexed signal received from a port #1. The received optical multiplexed signal is power-split by a splitter (SPL: Splitter) 3 of a demultiplexing part 2-1 corresponding to the port #1 and supplied to wavelength selected switches (WSS) 4 of the optical transmitter-receiver parts corresponding to ports #2 to #8. The optical multiplexed signal power-split by the splitter (SPL) 3 is also supplied to splitters (SPL) 7-1 to 7-8 via respective optical amplifiers.

Similarly, an optical transmitter-receiver part 1-8 receives an optical multiplexed signal received from a port #8. The received optical multiplexed signal is power-split by a splitter (SPL: Splitter) 3 of a demultiplexing part 2-8 corresponding to the port #8 and supplied to wavelength selected switches (WSS) 4 of the optical transmitter-receiver parts corresponding to ports #1 to #7. The optical multiplexed signal power-split by the splitter (SPL) 3 is also supplied to splitters (SPL) 8-1 to 8-8 via respective optical amplifiers.

The optical signals power-split by the splitters (SPL) 7-1 to 7-8 are supplied to optical cross connect switches (OXC) 9 and 10 to switch outgoing paths of the supplied optical signals based on their respective wavelengths. The wavelengths of the optical signals are then selected by tunable filters (TF) 11 and 12 based on wavelength units, and the optical signals are then supplied to transponders (TP) 13a to 13d based on the wavelengths selected by tunable filters (TF) 11 and 12. The transponders 13a to 13d convert the optical signals into electric signals and encapsulate the electric signals in frames. The transponders 13a to 13d convert the framed electric signals into wideband optical signals to send the wideband optical signals to a client.

Similarly, the optical signals power-split by the splitters (SPL) 8-1 to 8-8 are supplied to optical cross connect switches (OXC) 14 and 15 to switch outgoing paths of the supplied optical signals based on their respective wavelengths. The wavelengths of the optical signals are then selected by the tunable filters (TF) 16 and 17, and the optical signals are then supplied to transponders (TP) 18a to 18d based on the wavelengths selected by the tunable filters (TF) 16 and 17. The transponders 18a to 18d convert the optical signals into electric signals and encapsulate the electric signals in frames. The transponders 13a to 13d convert the framed electric signals into wideband optical signals to send the converted wideband optical signals to the client.

The transponders (TP) 21a to 21d serve as optical transmitter-receiver devices so that the transponders (TP) 21a to 21d convert the wideband optical signals received from the client into electric signals, and encapsulate the electric signals in frames. The transponders 21a to 21d further convert the framed electric signals into narrowband optical signals to supply the converted narrowband optical signals to tunable filters (TF) 22 and 23. The wavelengths of the narrowband optical signals selected by the tunable filters (TF) 22 and 23 are supplied to optical cross connect switches (OXC) 24 and 25 to switch outgoing paths of the supplied narrowband optical signals based on their the wavelengths. The narrowband optical signals are then supplied to transmitting couplers (CPL) 26-1 to 26-8. The transmitting couplers (CPL) 26-1 to 26-8 then multiplex the supplied optical signals. Subsequently, the multiplexed optical signals output from the transmitting couplers (CPL) 26-1 to 26-8 are supplied to respective couplers (CPL) 6 of the demultiplexing parts 2-1 to 2-8.

The transponders (TP) 21a to 21d serve as optical transmitter-receiver devices so that the transponders (TP) 21a to 21d convert the wideband optical signals received from the client into electric signals, and encapsulate the electric signals in frames. The transponders 21a to 21d further convert the framed electric signals into narrowband optical signals to supply the converted narrowband optical signals to tunable filters (TF) 28 and 29. The wavelengths of the narrowband optical signals selected by the tunable filters (TF) 28 and 29 are supplied to optical cross connect switches (OXC) 30 and 31 to switch outgoing paths of the supplied narrowband optical signals based on their the wavelengths. The narrowband optical signals are then supplied to transmitting couplers (CPL) 32-1 to 32-8. The transmitting couplers (CPL) 32-1 to 32-8 then multiplex the supplied optical signals. Subsequently, the multiplexed optical signals output from the transmitting couplers (CPL) 32-1 to 32-8 are supplied to respective couplers (CPL) 6 of the demultiplexing parts 2-1 to 2-8.

The respective couplers (CPL) 6 of the demultiplexing parts 2-1 to 2-8 multiplex the multiplexed optical signals supplied from the transmitting couplers (CPL) 26-1 to 26-8 and 32-1 to 32-8 to supply the multiplexed optical signals to the corresponding wavelength selected switches (WSS) 4. The wavelength selected switches (WSS) 4 multiplex the optical signals supplied from the respective ports #1 to #8 using different the wavelengths and send the multiplexed optical signals from the respective ports #1 to #8 via the optical transmitter-receiver parts 1-1 to 1-8.

In the related art technology, every optical fiber connection is tested by applying the amplitude modulation of the low frequency to signal light of an optical fiber connecting source, and allowing photodetectors (PD) disposed in optical fiber connecting destinations to detect the modulated frequency to test whether a signal is sent from desired destinations.

For example, optical fiber connections from the transponder (TP) 27a to the optical transmitter-receiver part 1-8 are tested by performing the optical fiber connecting test from the transponder (TP) 27a to the tunable filter (TF) 28, the optical fiber connecting test from the tunable filter (TF) 28 to the optical cross connect switch (OXC) 30, the optical fiber connecting test from the optical cross connect switch (OXC) 30 to the coupler (CPL) 32-8, the optical fiber connecting test from the coupler 32-8 to the coupler 6 of demultiplexing part 2-8, and the optical fiber connecting test from the coupler 6 of demultiplexing part 2-8 to the wavelength selected switch (WSS) 4.

Further, there is a technology of determining whether optical fiber connection information between devices is matched. In the disclosed technology, the transmitter includes: storing a connection information storage means 401 for storing connection information between devices having an identifier concerning a transmitter 1 and an identifier concerning a transmitter 31, generating control frame data having the identifier associated with the transmitter 1, transmitting the control frame data to the transmitter 31 via the communication cable while receiving the returned control frame data, and extracting the identifier from the received control frame data, thereby determining whether the extracted identifier matches the identifier contained in the connection information between devices (e.g., Patent Document 1).

Further, there is disclosed a technology of determining whether an optical fiber connection status is normal (i.e., intact connection). The technology includes transmitting an optical signal of a unique signal pattern generated by switching between a status of the presence of an optical signal and a status of the absence of an optical signal for each bidirectional port pair, receiving an optical signal so as to loop it back to a transmitting port paired with a receiving port, and detecting a receiving pattern from a loopback signal, thereby determining a normal connection status when the detected pattern is identical to the signal pattern transmitted from the transmitting port paired with the receiving port that receives the receiving pattern (e.g., Patent Document 2).

In addition, there is disclosed a technology for controlling an output level of excitation light based on a connection status of an optical fiber. In this technology, the optical amplifier includes one amplifier board 10 for receiving and outputting WDM signal light Ls, and a plurality of booster boards for supplying excitation light Lp to the amplifier board. An ID pattern generated in an ID pattern generation circuit provided inside each booster board is superimposed on the excitation light Lp and sent to the amplifier board, electric signals Sm indicating the monitoring result of the excitation light Lp in a light receiving unit 16 provided inside the amplifier board are transmitted to the corresponding booster boards, whether the received ID pattern included in the electric signals matches the generated ID pattern is detected in an ID matching detection circuit inside the booster board, and the connection status of an output fiber is decided in accordance with the detected result, thereby controlling the output level of the excitation light Lp (e.g., Patent Document 3).

Further, there is disclosed a technology of detecting the erroneous connection of an optical fiber. In this technology, a node identifier of a self-node and an identifier of an interface for receiving and outputting a signal are set in a predetermined first field of a header and transmitted to a receiving side node, both the identifiers are set in a predetermined second field of the header, transmitted together with the first field and stored in the first field from the receiving side node. When receiving the identifiers set in the first and second fields, it is determined whether the connection of the optical fiber is erroneous or normal by matching the identifiers of the second field and the identifies of the first field (e.g., Patent Document 4).

### RELATED-ART DOCUMENT

Patent Document 1: Japanese Laid-open Patent Publication No. 2010-171694
Patent Document 2: Japanese Laid-open Patent Publication No. 2008-288993
Patent Document 3: Japanese Laid-open Patent Publication No. 2006-135651
Patent Document 4: Japanese Laid-open Patent Publication No. 2008-72462

There are numerous optical fibers utilized by the node in the CDC system. For example, several hundreds to several thousands of optical fiber connections may need to be provided in the system utilizing an optical signal with 8 paths and 88 wavelength channels. Further, in the CDC system, if a port to which the optical signal is transmitted is erroneously connected (if an optical path is erroneously selected), wavelengths may collide with one another, which may cause an error in the existing signals or may transmit a signal to a wrong port (erroneously selected path).

However, with the configuration in which modulation units are provided at the connection sources and photodetectors are provided at the connection destinations for all the optical fiber connections, the size of the node device may be increased and accordingly the cost may be extremely increased. Further, since modulation frequencies may need to be provided according to the number of optical fiber connections, the photodetectors of the connection destinations for detecting the corresponding frequencies may require high accuracy, which may also increase the cost.

### SUMMARY

According to an aspect of an embodiment, a node device includes a data pattern generator configured to generate different fixed patterns for a plurality of ports to insert the generated fixed patterns into optical signals output from a plurality of optical transmitters; an optical switch configured to switch outgoing paths of the optical signals to output the optical signals as a multiplexed signal from one of the ports; a detector configured to detect a frequency spectrum of the multiplexed optical signal; and a management part configured to monitor a peak frequency of the detected frequency spectrum to detect an erroneous optical fiber connection associated with the optical transmitters based on peak frequencies corresponding to the different fixed patterns for the respective ports.

The object and advantages of the invention will be realized and attained by means of the elements and combinations particularly pointed out in the appended claims.

It is to be understood that both the foregoing general description and the following detailed description are exemplary and explanatory and are not restrictive of the invention, as claimed.

Additional objects and advantages of the embodiments will be set forth in part in the description which follows, and in part will be obvious from the description, or may be learned by practice of the invention.

### BRIEF DESCRIPTION OF THE DRAWINGS

FIG. 1 is a configuration diagram illustrating an example of a related art node device;

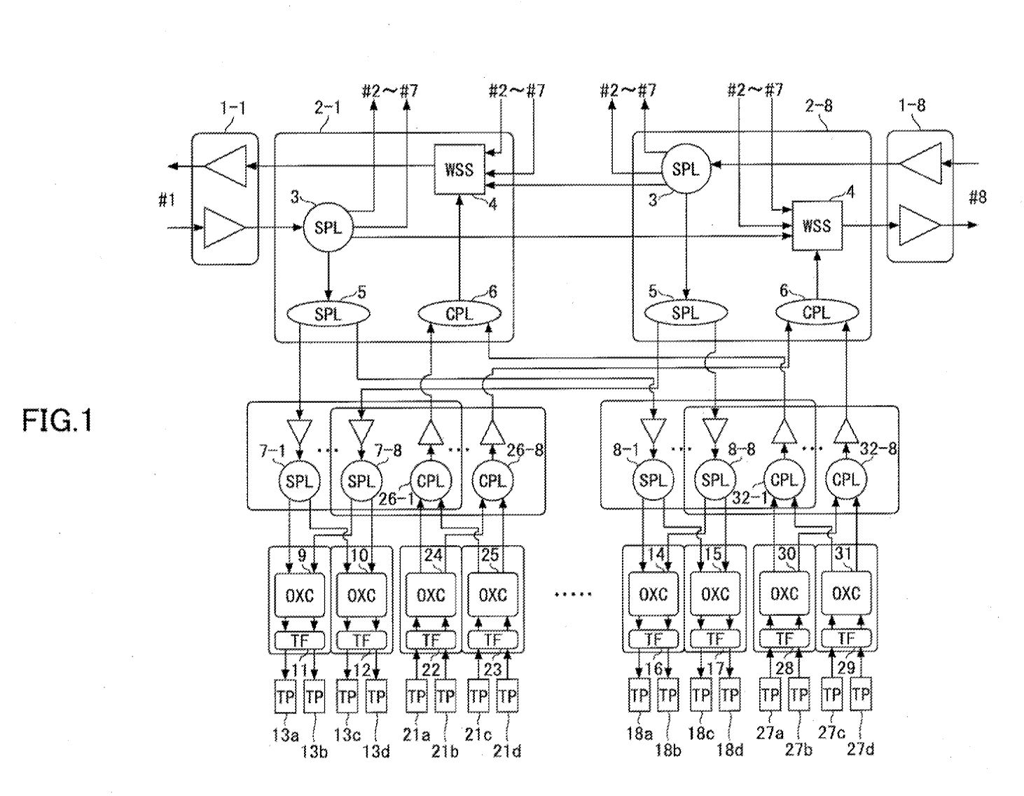

FIG. 2 is a configuration diagram illustrating an optical wavelength multiplexing transmission system according to an embodiment;

FIG. 3 is a configuration diagram illustrating a node device according to a first embodiment;

FIGS. 4A, 4B, and 4C are diagrams illustrating a difference between peak frequencies corresponding to fixed patterns;

FIG. 5 is a flowchart illustrating erroneous optical fiber connection monitoring processing;

FIG. 6 is a configuration diagram illustrating modification of the node device according to the first embodiment; and

FIG. 7 is a configuration diagram illustrating a node device according to a second embodiment.

### DESCRIPTION OF EMBODIMENTS

According to preferred embodiments, an erroneous optical fiber connection may be detected with a simpler configuration of a node device.

In the following, a description is given, with reference to the accompanying drawings, of the embodiments.

[Optical Wavelength Multiplexing Transmission System]

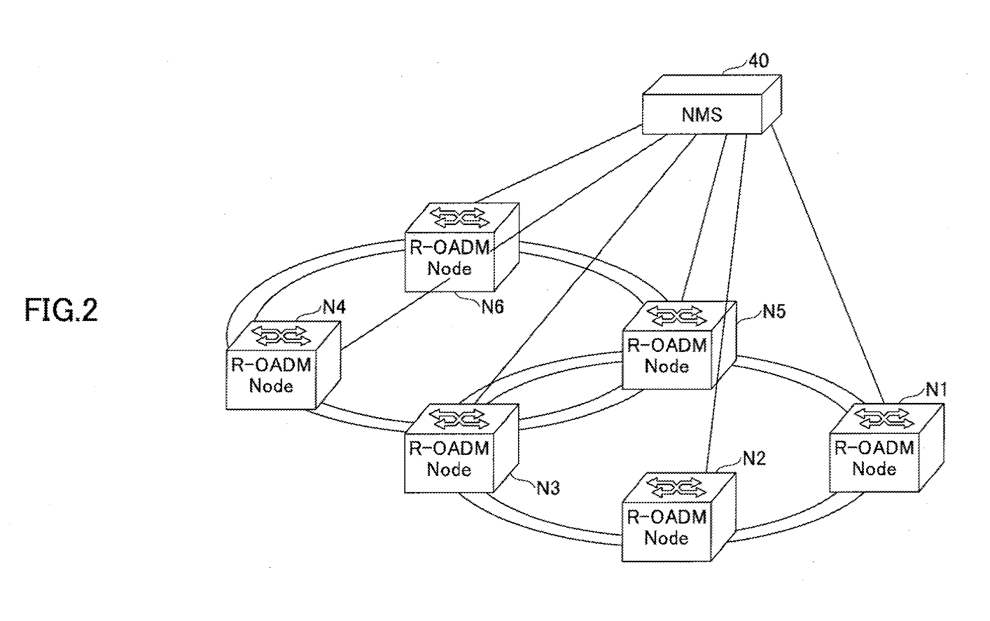

FIG. 2 is a configuration diagram of an optical wavelength multiplexing transmission system according to an embodiment. As illustrated in FIG. 2, a network is constructed by connecting an optical fiber between nodes N1, N2, N3, and N4 and also between nodes N3, N4, N6, and N5. Each of the nodes N1 to N6 is formed of a reconfigurable optical add/drop multiplexer (ROADM) that is capable of reconfiguring an optical wavelength and an optical path. Each of the nodes N1 to N6 is connected to a network management system (NMS) 40 configured to control monitoring of the entire network. Note that NMS 40 may not necessarily be connected to each of the nodes N1 to N6. The NMS 40 may only be connected to one of the nodes N1 to N6 (e.g., node N1). If the NMS 40 is connected, for example, to the node N1, the NMS 40 may be connected from node N1 to other nodes N2 to N6 via the network.

[Node Device According to First Embodiment]

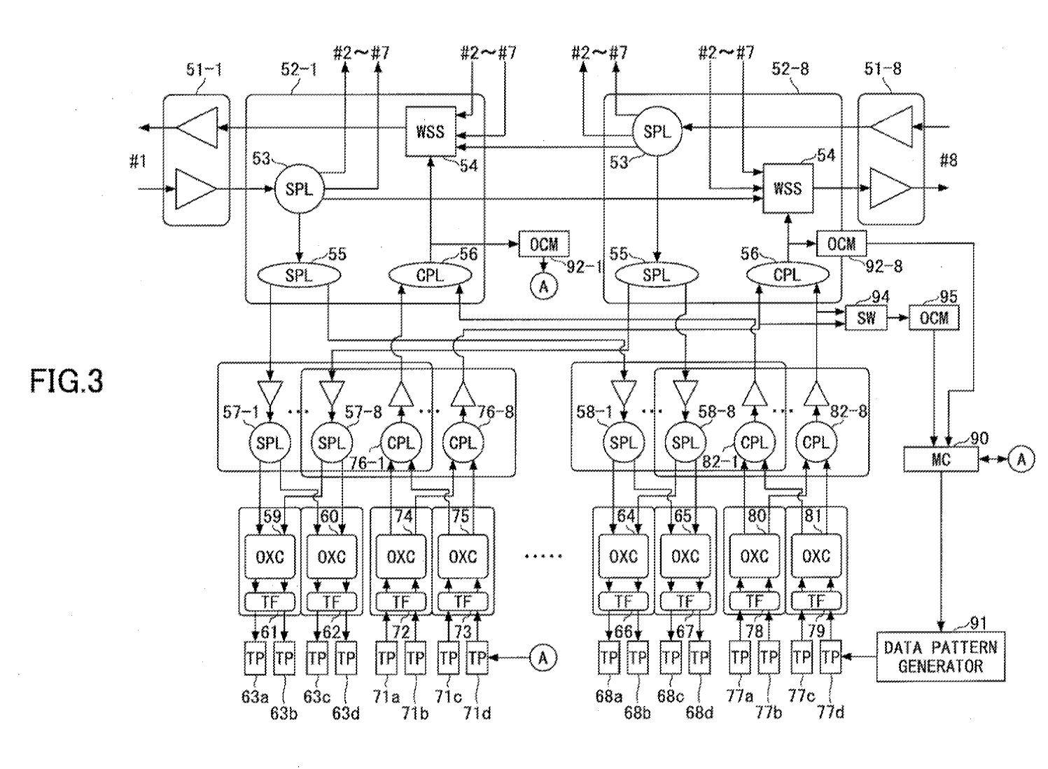

FIG. 3 illustrates a configuration diagram of a node device having a CDC function according to a first embodiment. As illustrated in FIG. 3, an optical transmitter-receiver part 51-1 receives an optical multiplexed signal from a port #1. The optical multiplexed signal is power-split by a splitter (SPL: Splitter) 53 of a demultiplexing part 52-1 corresponding to the port #1. The power-split optical signals are supplied to wavelength selected switches (WSS) 54 of the optical transmitter-receiver parts corresponding to ports #2 to #8. Simultaneously, the power-split optical signals are also supplied to a splitter 55 of the demultiplexing part 52-1 to split power of the optical signals. The power-split optical signals are then supplied to splitters (SPL) 57-1 to 57-8 via optical amplifiers.

Similarly, an optical transmitter-receiver part 51-8 amplifies an optical multiplexed signal received from a port #8. The amplified optical multiplexed signal is power-split by a splitter (SPL: Splitter) 53 of a demultiplexing part 52-8 corresponding to the port #8. The power-split optical signals are supplied to wavelength selected switches (WSS) 54 of the optical transmitter-receiver parts corresponding to ports #1 to #7. Simultaneously, the power-split optical signals are also supplied to a splitter 55 of the demultiplexing part 52-8 to split power of the optical signals. The power-split optical signals are then supplied to receiving splitters (SPL) 58-1 to 58-8 via optical amplifiers.

The optical signals power-split by the splitters (SPL) 57-1 to 58-8 are supplied to optical cross connect switches (OXC) 59 and 60 to switch outgoing paths of the supplied optical signals based on their respective wavelengths. The wavelengths of the optical signals are then selected by the tunable filters (TF) 61 and 62 based on wavelength units, and the optical signals are then supplied to transponders (TP) 63a to 63d based on the wavelengths selected by the tunable filters (TF) 61 and 62. The transponders 63a to 63d convert the received optical signals into electric signals and encapsulate the electric signals in frames. The transponders 63a to 63d further convert the framed electric signals into wideband optical signals to send the converted wideband optical signals to a client.

Similarly, the optical signals power-split by the splitters (SPL) 58-1 to 58-8 are supplied to optical cross connect switches (OXC) 64 and 65 to switch outgoing paths of the supplied optical signals based on their respective wavelengths. The wavelengths of the optical signals are then selected by the tunable filters (TF) 66 and 67 based on wavelength units, and then the optical signals are then supplied to transponders (TP) 68a to 68d based on the wavelengths selected by the tunable filters (TF) 66 and 67. The transponders 68a to 68d convert the received optical signals into electric signals and encapsulate the electric signals in frames. The transponders 68a to 68d further convert the framed electric signals into wideband optical signals to send the converted wideband optical signals to the client.

The transponders (TP) 71a to 71d serve as optical transmitter-receiver devices so that the transponders (TP) 71a to 71d convert the wideband optical signals received from the client into electric signals, and encapsulate the electric signals in frames. The transponders 21a to 21d further convert the framed electric signals into narrowband optical signals to supply the converted narrowband optical signals to tunable filters (TF) 72 and 73. The wavelengths of the narrowband optical signals selected by the tunable filters (TF) 72 and 73 are supplied to optical cross connect switches (OXC) 74 and 75 to switch outgoing paths of the supplied narrowband optical signals based on their the wavelengths. The narrowband optical signals are then supplied to transmitting couplers (CPL) 76-1 to 76-8. The transmitting couplers (CPL) 76-1 to 76-8 then multiplex the supplied optical signals. Subsequently, the multiplexed optical signals output from the transmitting couplers (CPL) 76-1 to 76-8 are then supplied to respective couplers (CPL) 56 of the demultiplexing parts 52-1 to 52-8.

The transponders (TP) 77a to 77d serve as optical transmitter-receiver devices so that the transponders (TP) 77a to 77d convert the wideband optical signals received from the client into electric signals and encapsulate the electric signals in frames. The transponders 77a to 77d further convert the framed electric signals into narrowband optical signals to supply the converted narrowband optical signals to tunable filters (TF) 78 and 79. The wavelengths of the narrowband optical signals selected by the tunable filters (TF) 78 and 79 are supplied to optical cross connect switches (OXC) 80 and 81 to switch outgoing paths of the supplied narrowband optical signals based on their the wavelengths. The narrowband optical signals are then supplied to transmitting couplers (CPL) 82-1 to 82-8. The transmitting couplers (CPL) 82-1 to 82-8 then multiplex the supplied optical signals. Subsequently, the multiplexed optical signals output from the transmitting couplers (CPL) 82-1 to 82-8 are then supplied to respective couplers (CPL) 56 of the demultiplexing parts 52-1 to 52-8.

Note that each of the optical cross connect switches (OXC) may switch between 8×8 wavelengths and each of the tunable filters (TF) may select between 8 wavelengths. Hence, the maximum number of 8 transponders may be connected to each of the tunable filters (TF).

The respective couplers (CPL) 56 of the demultiplexing parts 52-1 to 52-8 multiplex the multiplexed optical signals supplied from the transmitting couplers (CPL) and supply the multiplexed optical signals to the wavelength selected switches (WSS) 54. The wavelength selected switches (WSS) 54 select wavelengths of the optical signals received from the ports #1 to #8, multiplex the optical signals of the selected wavelengths, and send the multiplexed optical signals from the respective ports #1 to #8 via the optical transmitter-receiver parts 51-1 to 51-8.

Note that tunable devices are utilized for all the wavelength selected switches (WSS) 54, the tunable filters (TF) 61, 62, 66, 67, 72, 73, 78, and 79, and the transponders (TP) 71a to 71d, 77a to 77d. Likewise, tunable devices are utilized for local oscillation light generators inside coherent optical receivers of the transponders 63a to 63d, and 68a to 68d.

These tunable devices modulate wavelengths of transmitting, receiving or oscillating optical signals based on the control of the management complex (MC) 90.

As a result, the colorless function of the CDC function may be implemented. Further, the optical signals split by the splitters 55 of the respective demultiplexing parts 52-1 to 52-8 are supplied to the optical cross connect switches (OXC) 59, 60, 64 and 65, and to the optical cross connect switches (OXC) 74, 75, 80 and 81 to switch outgoing paths of the supplied optical signals. The optical signals having their outgoing paths switched are then supplied to the respective couplers (CPL) 56 of the demultiplexing parts 52-1 to 52-8. As a result, the directionless function of the CDC function may be implemented.

The data pattern generator 91 generates specific fixed patterns corresponding to the outgoing paths of the optical signals and supplies the generated specific fixed patterns to the transponders 71a to 71d or the transponders 77a to 77d, based on the control of the management complex (MC) 90. Note that the data pattern generator 91 may be incorporated in the management complex (MC) 90. For example, the data pattern generator 91 may be formed of a pulse generator.

With such a configuration, the transponders 71a to 71d and the transponders 77a to 77d may insert the specific fixed patterns generated corresponding to outgoing paths into the respective overhead portions of the optical signals and output such optical signals accompanying the specific fixed patterns. For example, the transponder (e.g., transponder 77a) is configured to output the optical signal in an outgoing path of the port #1, so that the data pattern generator 91 supplies a fixed pattern “101010101010” to the transponder 77a, the transponder (e.g., transponder 77b) is configured to output the optical signal in an outgoing path of the port #2, so that the data pattern generator 91 supplies a fixed pattern “100100100100” to the transponder 77b, and the transponder (e.g., transponder 77d) is configured to output the optical signal in an outgoing path of the port #8, so that the data pattern generator 91 supplies a fixed pattern “100010001000” to the transponder 77d. Note that the fixed pattern may not necessarily be inserted into the overhead portion of the optical signal but may be inserted in a payload portion of the optical signal. However, if the fixed pattern is inserted in the payload portion, the (scrambled) payload portion may need to be descrambled.

Further, optical channel monitors (OCM) 92-1 to 92-8 are provided for couplers (CPL) 56 of the demultiplexing parts 52-1 to 52-8 corresponding to the ports #1 to #8 such that the optical channel monitors (OCM) 92-1 to 92-8 may monitor the optical signals output from the couplers (CPL) 56 of the demultiplexing parts 52-1 to 52-8. The output results of the optical channel monitors 92-1 to 92-8 are supplied to the management complex (MC) 90.

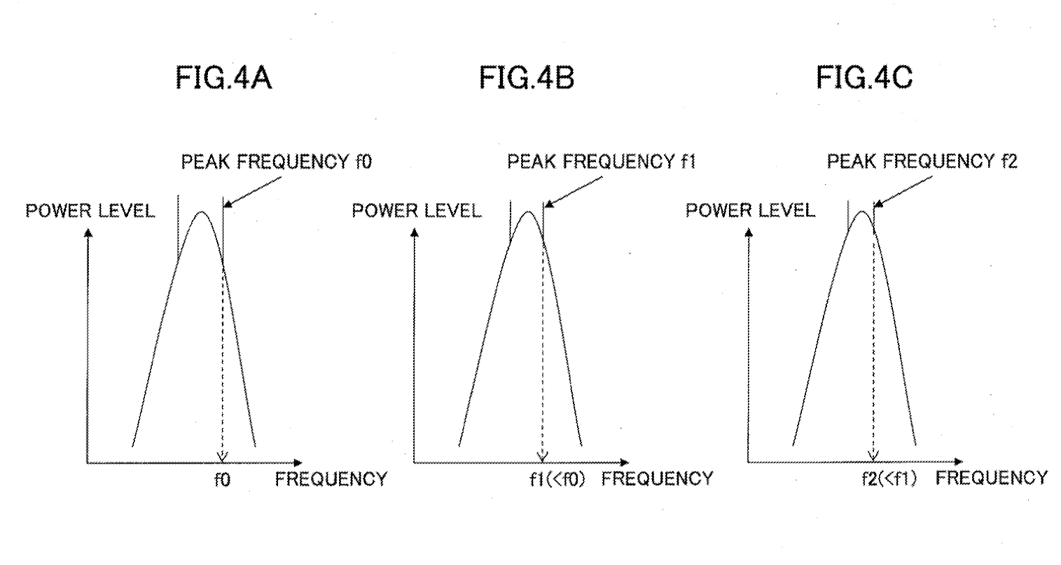

For example, when the optical signal having a first fixed pattern “101010101010” is supplied to the optical channel monitors 92-1 to 92-8, the optical channel monitors 92-1 to 92-8 each output a frequency spectrum having a peak frequency f0 illustrated in FIG. 4A. Similarly, when the optical signal having a second fixed pattern “100100100100” is supplied to the optical channel monitors 92-1 to 92-8, the optical channel monitors 92-1 to 92-8 each output a frequency spectrum having a peak frequency f1 (f1<f0) illustrated in FIG. 4B. Further, when the optical signal having a third fixed pattern “100010001000” is supplied to the optical channel monitors 92-1 to 92-8, the optical channel monitors 92-1 to 92-8 each output a frequency spectrum having a peak frequency f2 (f2<f1) illustrated in FIG. 4C. That is, the optical channel monitors 92-1 to 92-8 may output spectra having different peak frequencies based on the different fixed patterns.

Accordingly, the management complex (MC) 90, for example, supplies the third fixed pattern “100010001000” to the transponder (e.g., transponder 77d) configured to output an optical signal from the outgoing path to the port #8 and monitors the frequency spectrum supplied from the optical channel monitor 92-8 of the port #8. Further, if the frequency spectrum contains the peak frequency f2, the management complex (MC) 90 determines that the optical fiber connections from the transponder 77d to the wavelength selected switch (WSS) 54 are normal (intact). If, on the other hand, the frequency spectrum does not contain the peak frequency f2, the management complex (MC) 90 determines that the optical fiber connections from the transponder 77d to the wavelength selected switch (WSS) 54 are abnormal (defective). If the frequency spectrum contains the peak frequency f0 or the peak frequency f1, the management complex (MC) 90 determines that the optical fiber connections from the transponder 77a or 77b to the wavelength selected switch (WSS) 54 are abnormal (defective). When the management complex (MC) 90 determines that the optical fiber connections are abnormal (defective), an alarm is generated.

Note that instead of providing the optical channel monitors (OCM) 92-1 to 92-8, the optical signals to be supplied to the respective couplers (CPL) 56 of the demultiplexing parts 52-1 to 52-8 may be supplied to an optical switch 94. In this case, the optical signals supplied to the optical switch 94 may then be sequentially supplied to an optical channel monitor (OCM) 95 by allowing the management complex (MC) 90 to control switching of the optical switch 94, and the frequency spectrum output from the optical channel monitor 95 may be supplied to the management complex (MC) 90. Note that the management complex (MC) 90 may be formed of a circuit, a field-programmable gateway array (FPGA) and a processor.

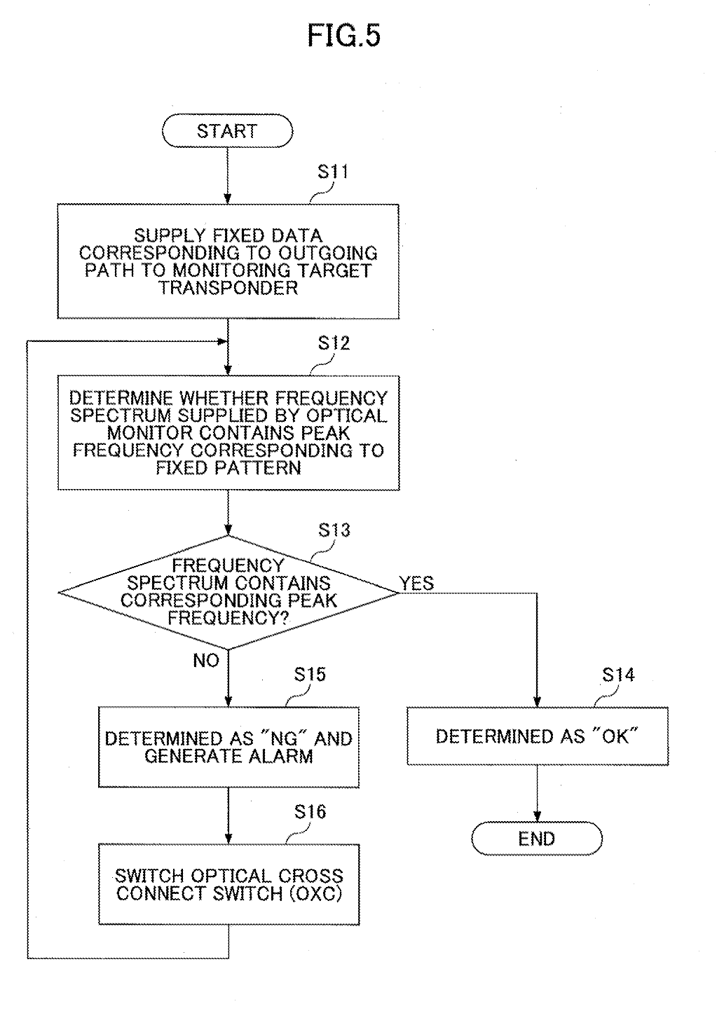

FIG. 5 is a flowchart illustrating an example of erroneous optical fiber connection monitoring processing executed by a management complex (MC) 90. As illustrated in FIG. 5, in step S11, the management complex (MC) 90 supplies a fixed pattern (e.g., a third fixed pattern “100010001000”) generated from a data pattern generator 91 to a monitoring target transponder (e.g., a transponder 77d in FIG. 3), with the fixed pattern being corresponding to an outgoing path (e.g., the port #8 in FIG. 3) to which an optical signal is to be supplied by the transponder 77d.

In step S12, the management complex (MC) 90 receives a frequency spectrum supplied by an optical channel monitor (e.g., 92-8 in FIG. 3) monitoring the outgoing path (i.e., the port #8) and determines whether the received frequency spectrum contains a peak frequency corresponding to the third fixed pattern (e.g., the peak frequency f2 in FIG. 4C). In step S13, if the received frequency spectrum contains the peak frequency corresponding to the third fixed pattern (“YES” in step S13), the result is determined as “OK” and the erroneous optical fiber connection monitoring processing is terminated (end of the monitoring processing).

If, on the other hand, the received frequency spectrum does not contain the peak frequency corresponding to the third fixed pattern (“NO” in step S13), the result is determined as “NG” and an alarm is generated in step S15. Subsequently, in step S16, the management complex (MC) 90 switches an optical cross connect switch (e.g., the optical cross connect switch (OXC) 81 in FIG. 3) switching the outgoing path to another one to which the optical signal is to be supplied by the transponder 77d. Thereafter, step S12 is processed again.

Thus, even if the optical fibers are erroneously connected, the optical signal output by the transponder subject to monitoring may be output from a desired one of the outgoing paths. Note that in step S16, the management complex (MC) 90 may receive all the frequency spectra supplied by optical channel monitors (e.g., 92-1 to 92-8 in FIG. 3) monitoring the corresponding outgoing paths, determine which one of the received frequency spectra contains the peak frequency corresponding to the third fixed pattern (i.e., the peak frequency f2 in FIG. 4C), and switch the optical cross connect switch (OXC) 81 to switch the outgoing path to the desired path to which the transponder supplies the optical signal.

In the first embodiment, the erroneous optical fiber connection may be detected by the simple configuration having the data pattern generator and the optical channel monitor (OCM). Further, the number of fixed patterns may be limited to the number of the paths to which the optical signal is supplied in the processing of detecting the most serious erroneous optical fiber connection.

[Modification of Node Device According to First Embodiment]

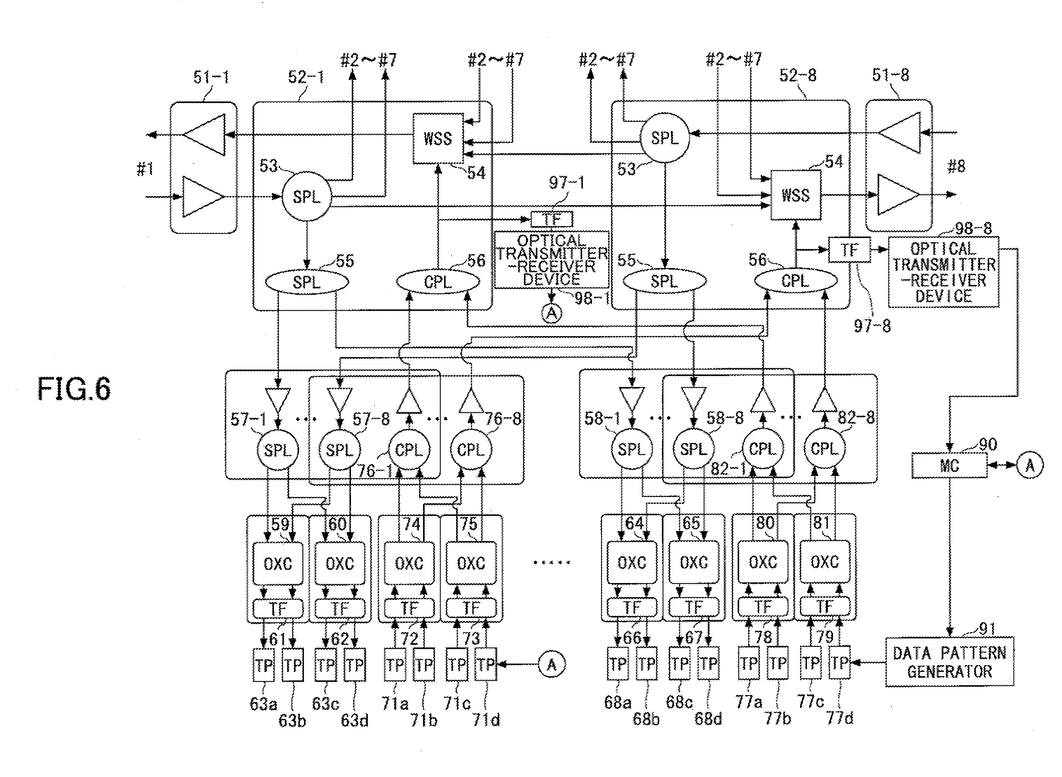

FIG. 6 illustrates a configuration diagram of a modified example of the node device having the CDC function according to the first embodiment. The modified configuration illustrated in FIG. 6 differs from the configuration according to the first embodiment illustrated in FIG. 3 in the following points. The output light (optical signal) from the respective couplers (CPL) 56 of the demultiplexing parts 52-1 to 52-8 corresponding to the ports #1 to #8 is supplied to optical receivers 98-1 to 98-8 via the tunable filters (TF) 97-1 to 97-8 instead of the optical channel monitors (OCM) 92-1 to 92-8, and the light output from the optical receivers 98-1 to 98-8 is then supplied to the management complex (MC) 90.

In FIG. 6, the tunable filters (TF) 97-1 to 97-8 sweep passed through wavelengths in the order from the shortest to the longest wavelengths and the wavelengths passed through the tunable filters (TF) 97-1 to 97-8 are supplied to the optical receivers 98-1 to 98-8. In the optical receivers 98-1 to 98-8, frequency spectra illustrated in FIGS. 4A to 4C that are obtained in a digital processing phase prior to a decoding phase of decoding the optical signal are used in the management complex (MC) 90 which executes the erroneous optical fiber connection monitoring processing.

Note that if the optical receivers 98-1 to 98-8 are configured to coherently receive light, received wavelengths may be scanned (swept) by wavelength tunable devices provided in local oscillation light generators inside the optical receivers 98-1 to 98-8. Accordingly the tunable filters (TF) 97-1 to 97-8 may be omitted from the node device.

Further, among the transponders 71a to 71d and 77a to 77d, the data pattern generator 91 generates a specific fixed pattern corresponding to an outgoing path of a monitoring target transponder and a slot number as location information for locating the monitoring target transponder. The generated specific fixed pattern and the slot number as setting information are supplied to the monitoring target transponder. The monitoring target transponder generates an optical signal having the fixed pattern and the slot number in its overhead portion. Note that the slot number is information to specify a slot that locates the monitoring target transponder in the node device.

In this case, the optical receivers 98-1 to 98-8 may extract the fixed pattern and the slot number from the overhead portion of the received optical signal, and supply the extracted fixed pattern and the slot number to the management complex (MC) 90. As a result, the management complex (MC) 90 may be able to monitor the (erroneous) optical fiber connection of the monitoring target transponder.

[Node Device According to Second Embodiment]

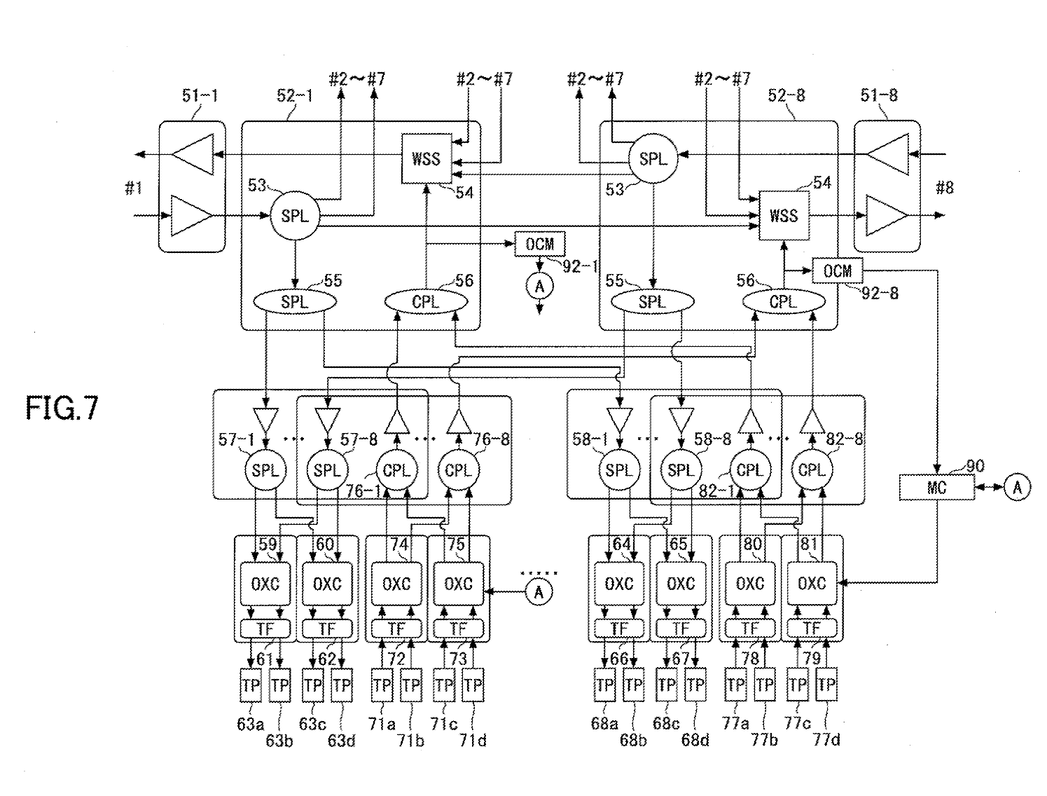

FIG. 7 illustrates a configuration diagram of a node device having the CDC function according to a second embodiment. As illustrated in FIG. 7, an optical transmitter-receiver part 51-1 receives an optical multiplexed signal from a port #1. The optical multiplexed signal is power-split by a splitter (SPL: Splitter) 53 of a demultiplexing part 52-1 corresponding to the port #1. The power-split optical signals are supplied to wavelength selected switches (WSS) 54 of the optical transmitter-receiver parts corresponding to ports #2 to #8. Simultaneously, the power-split optical signals are also supplied to a splitter 55 of the demultiplexing part 52-1 to split power of the optical signals. The power-split optical signals are then supplied to splitters (SPL) 57-1 to 57-8 via optical amplifiers.

Similarly, an optical transmitter-receiver part 51-8 amplifies an optical multiplexed signal received from a port #8. The amplified optical multiplexed signal is power-split by a splitter (SPL: Splitter) 53 of a demultiplexing part 52-8 corresponding to the port #8. The power-split optical signals are supplied to wavelength selected switches (WSS) 54 of the optical transmitter-receiver parts corresponding to ports #1 to #7. Simultaneously, the power-split optical signals are also supplied to a splitter 55 of the demultiplexing part 52-8 to split power of the optical signals. The power-split optical signals are then supplied to receiving splitters (SPL) 58-1 to 58-8 via optical amplifiers.

The optical signals power-split by the splitters (SPL) 57-1 to 58-8 are supplied to optical cross connect switches (OXC) 59 and 60 to switch outgoing paths of the supplied optical signals based on their respective wavelengths. The wavelengths of the optical signals are then selected by the tunable filters (TF) 61 and 62 based on wavelength units, and the optical signals of the selected wavelengths are then supplied to transponders (TP) 63a to 63d based on the wavelengths selected by the tunable filters (TF) 61 and 62. The transponders 63a to 63d convert the received optical signals into electric signals and encapsulate the electric signals in frames. The transponders 63a to 63d further convert the framed electric signals into wideband optical signals to send the converted wideband optical signals to a client.

Similarly, the optical signals power-split by the splitters (SPL) 58-1 to 58-8 are supplied to optical cross connect switches (OXC) 64 and 65 to switch outgoing paths of the supplied optical signals based on their respective wavelengths. The wavelengths of the optical signals are then selected by the tunable filters (TF) 66 and 67 based on wavelength units, and then the optical signals are then supplied to transponders (TP) 68a to 68d based on the wavelengths selected by the tunable filters (TF) 66 and 67. The transponders 68a to 68d convert the received optical signals into electric signals and encapsulate the electric signals in frames. The transponders 68a to 68d further convert the framed electric signals into wideband optical signals to send the converted wideband optical signals to the client.

The transponders (TP) 71a to 71d serve as optical transmitter-receiver devices so that the transponders (TP) 71a to 71d convert the wideband optical signals received from the client into electric signals, and encapsulate the electric signals in frames. The transponders 21a to 21d further convert the framed electric signals into narrowband optical signals to supply the converted narrowband optical signals to tunable filters (TF) 72 and 73. The wavelengths of the narrowband optical signals selected by the tunable filters (TF) 72 and 73 are supplied to optical cross connect switches (OXC) 74 and 75 to switch outgoing paths of the supplied narrowband optical signals based on their the wavelengths. The narrowband optical signals are then supplied to transmitting couplers (CPL) 76-1 to 76-8. The transmitting couplers (CPL) 76-1 to 76-8 then multiplex the supplied optical signals. Subsequently, the multiplexed optical signals output from the transmitting couplers (CPL) 76-1 to 76-8 are then supplied to respective couplers (CPL) 56 of the demultiplexing parts 52-1 to 52-8.

The transponders (TP) 77a to 77d serve as optical transmitter-receiver devices so that the transponders (TP) 77a to 77d convert the wideband optical signals received from the client into electric signals and encapsulate the electric signals in frames. The transponders 77a to 77d further convert the framed electric signals into narrowband optical signals to supply the converted narrowband optical signals to tunable filters (TF) 78 and 79. The wavelengths of the narrowband optical signals selected by the tunable filters (TF) 78 and 79 are supplied to optical cross connect switches (OXC) 80 and 81 to switch outgoing paths of the supplied narrowband optical signals based on their the wavelengths. The narrowband optical signals are then supplied to transmitting couplers (CPL) 82-1 to 82-8. The transmitting couplers (CPL) 82-1 to 82-8 then multiplex the supplied optical signals. Subsequently, the multiplexed optical signals output from the transmitting couplers (CPL) 82-1 to 82-8 are then supplied to respective couplers (CPL) 56 of the demultiplexing parts 52-1 to 52-8.

Note that each of the optical cross connect switches (OXC) may switch between 8×8 wavelengths and each of the tunable filters (TF) may select between 8 wavelengths. Hence, the maximum number of 8 transponders may be connected to each of the tunable filters (TF).

The respective couplers (CPL) 56 of the demultiplexing parts 52-1 to 52-8 multiplex the multiplexed optical signals supplied from the transmitting couplers (CPL) and supply the multiplexed optical signals to the wavelength selected switches (WSS) 54. The wavelength selected switches (WSS) 54 select wavelengths of the optical signals received from the ports #1 to #8, multiplex the optical signals of the selected wavelengths supplied from the respective ports #1 to #8, and send the multiplexed optical signals from the respective ports #1 to #8 via the optical transmitter-receiver parts 1-1 to 1-8.

Note that tunable devices are utilized for all the wavelength selected switches (WSS) 54, the tunable filters (TF) 61, 62, 66, 67, 72, 73, 78, and 79, and the transponders (TP) 71a to 71d, 77a to 77d. Likewise, tunable devices are utilized for local oscillation light generators inside coherent optical receivers of the transponders 63a to 63d, and 68a to 68d.

These tunable devices modulate wavelengths of transmitting, receiving or oscillating optical signals based on the control of the management complex (MC) 90. As a result, the colorless function of the CDC function may be implemented. Further, the optical signals split by the splitters 55 of the respective demultiplexing parts 52-1 to 52-8 are supplied to the optical cross connect switches (OXC) 59, 60, 64 and 65, and to the optical cross connect switches (OXC) 74, 75, 80 and 81 to switch outgoing paths of the supplied optical signals. The optical signals having their outgoing paths switched are then supplied to the respective couplers (CPL) 56 of the demultiplexing parts 52-1 to 52-8. As a result, the directionless function of the CDC function may be implemented.

As illustrated in FIG. 7, the data pattern generator 91 illustrated in FIG. 3 is not provided in the node device according to the second embodiment. In this configuration, the management complex (MC) 90 controls the optical cross connect switches (OXC) 74, 75, 80 and 81 to switch outgoing paths corresponding to the wavelengths. The management complex (MC) 90 controls the optical cross connect switches (OXC) 74, 75, 80 and 81 to change the amplitudes of the optical signals based on different frequencies (e.g., low frequencies of approximately 1 kHz) corresponding to the outgoing paths (to different ports) of the optical signals.

The optical cross connect switch (OXC) or the wavelength selected switch (WSS) has a signal output portion with an attenuator function. Thus, the above optical cross connect switches (OXC) may modulate the amplitudes of the optical signals utilizing their attenuator functions. That is, if the optical fibers are normally connected, a wavelength group output from the port #1 may be amplitude-modulated with a frequency f11, a wavelength group output from the port #2 may be amplitude-modulated with a frequency f12, and a wavelength group output from the port #8 may be amplitude-modulated with a frequency f18.

In the respective optical channel monitors (OCM) 92-1 to 92-8, a frequency of the amplitude modulation may be defined as “α” Hz, and the number of wavelength multiplexed optical signals output from each port may be defined as “n”. In this case, the optical channel monitors (OCM) 92-1 to 92-8 may scan (sweep) all the wavelengths of the multiplexed optical signals with the frequency of 2×n×α or above. That is, the optical channel monitors (OCM) 92-1 to 92-8 may monitor changes in the peak level of each of the wavelengths; that is, the peak level of the amplitude modulation in each of the wavelengths of the wavelength multiplexed optical signals and supply monitoring results to the management complex (MC) 90.

Accordingly, the management complex (MC) 90, for example, amplitude-modulates the optical signal by a frequency f18 at a signal output part of the optical cross connect switch (OXO) 81 in order to output the optical signal from the outgoing path of the port #8. The management complex (MC) 90 monitors the peak level of the amplitude modulation in each of the wavelengths of the optical signals supplied from the optical monitor 92-8 of the port #8. Further, if the peak level of the amplitude modulation in all the wavelengths of the optical signals indicates the frequency f18, the management complex (MC) 90 determines that the optical fiber connections from the optical cross connect switch (OXC) 81 to the wavelength selected switch (WSS) 54 of the demultiplexing part 52-8 are normal (intact). If, on the other hand, the peak level of the amplitude modulation does not indicate the frequency f18, or the peak level of the amplitude modulation indicates a frequency other than the frequency f18, the management complex (MC) 90 determines that the optical fiber connections from the optical cross connect switch (OXC) 81 to the wavelength selected switch (WSS) 54 of the demultiplexing part 52-8 are abnormal (defective) and generates an alarm.

[Node Device at Startup]

The transponders 63a to 63d, 68a to 68d, 71a to 71d, and 77a to 77d may not all necessarily have to function at startup of the node device. For example, whether the optical fiber connections from the transponders 71a to 71d and 77a to 77d are normal may be determined by sequentially connecting one of the transponders, such as the transponder 77a, to the tunable filters (TF) 66, 67, 78 and 79 so that a fixed pattern is supplied from the management complex (MC) 90 to the transponder 77a corresponding to an outgoing path of an output port determined based on the connected one of the tunable filters (TF) 66, 67, 78 and 79. Alternatively, whether the optical fiber connections from the transponders 71a to 71d and 77a to 77d are normal may be determined by amplitude-modulating the optical signal output from the optical cross connect switch (OXC) corresponding to a connected position of the transponder 77a.

[In-Service]

The transponder(s) may be added after the network construction. In this case, the transponder(s) may be added during in-service without adversely affecting existing signals and the optical signals subjected to the amplitude modulation.

In this case, the wavelength that is not utilized as a main signal within the node device and detectable by the optical cross connect switch (OXC) may be set in the additional transponder, and whether the optical fiber connection of the additional transponder is normal may be determined by the aforementioned the optical fiber connection detecting method according to the first or second embodiment. After the optical fiber connection of the additional transponder is determined as normal, the wavelength of the optical signal output by the additional transponder may be changed in a desired wavelength so that the optical signal having the desired wavelength may be output from the additional transponder. With this method, the erroneous optical fiber connection may be detected without adversely affecting the main signal.

In the embodiments described above, the erroneous optical fiber connection and the position of the erroneous optical fiber connection may be detected with a simplified configuration and a reduced size of the node device and at low cost in the optical fiber connection of the complicated CDC system. Accordingly, errors in the existing signals, or a signal output to an erroneous outgoing path due to an erroneous optical fiber connection may be prevented.

According to the aforementioned embodiments, the erroneous optical fiber connections may be detected with a simpler configuration.

The embodiments described so far are not limited thereto. Various modifications or alterations may be made within the scope of the inventions described in the claims.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority or inferiority of the invention. Although the embodiments of the present invention have been described in detail, it should be understood that various changes, substitutions, and alterations could be made hereto without departing from the spirit and scope of the invention.

What is claimed is:

1. A node device comprising:
a data pattern generator configured to generate different fixed patterns for a plurality of ports to insert the generated fixed patterns into optical signals output from a plurality of optical transmitters;
an optical switch configured to switch outgoing paths of the optical signals to output the optical signals as a multiplexed signal from one of the ports;
a detector configured to detect a frequency spectrum of the multiplexed optical signal; and
a management part configured to monitor a peak frequency of the detected frequency spectrum to detect an erroneous optical fiber connection associated with the optical transmitters based on peak frequencies corresponding to the different fixed patterns for the respective ports.

2. The node device as claimed in claim 1, wherein
when the management part detects the erroneous optical fiber connection, the management part controls the optical switch to switch a port from which the multiplexed signal is output to another port.

3. The node device as claimed in claim 1, wherein
the data pattern generator generates the different fixed patterns for the respective ports and location information for the respective optical transmitters to insert the generated fixed patterns and location information into the respective optical signals output from the optical transmitters,
the detector receives the respective optical signals output from the optical transmitters to extract the fixed patterns and location information from the received optical signals, and
the management part detects the erroneous optical fiber connection based on the extracted fixed pattern and location information.

4. The node device as claimed in claim 1, wherein
the detector is an optical monitor.

5. The node device as claimed in claim 1, wherein
the detector is an optical receiver.

6. A node device comprising:
an optical switch configured to switch outgoing paths of optical signals output from a plurality of optical transmitters to output the optical signals as a multiplexed signal from one of a plurality of ports;
an amplitude modulation part configured to amplitude-modulate the optical signals output from the optical transmitters or the optical signals output from the optical switch, with different frequencies corresponding to the ports;
a detector configured to detect amplitude change in each of wavelengths contained in the multiplexed signal output from a corresponding one of the ports;
a management part configured to monitor the respective amplitude changes to detect an erroneous optical fiber connection associated with the optical transmitters based on whether the amplitude changes contain the frequencies corresponding to the ports.

7. A method for detecting an erroneous optical fiber connection in a node device, the node device including an optical switch to switch outgoing paths of optical signals output from a plurality of optical transmitters to output the optical signals as a multiplexed signal from one of a plurality of ports, the method comprising:
generating different fixed patterns for the respective ports to insert the generated fixed patterns into the optical signals output from the respective optical transmitters;
optically monitoring a frequency spectrum of the multiplexed optical signal; and
monitoring a peak frequency of the detected frequency spectrum to detect the erroneous optical fiber connection associated with the optical transmitters based on peak frequencies corresponding to the different fixed patterns for the respective ports.

8. The method as claimed in claim 7, wherein
when the erroneous optical fiber connection is detected, a port from which the multiplexed signal is output is switched to another port.

9. A method for detecting an erroneous optical fiber connection in a node device, the node device including an optical switch to switch outgoing paths of optical signals output from a plurality of optical transmitters to output the optical signals as a multiplexed signal from one of a plurality of ports, the method comprising:
amplitude-modulating the optical signals output from the optical transmitters or the optical signals output from the optical switch, with different frequencies corresponding to the ports;
detecting amplitude change in each of wavelengths contained in the multiplexed signal output from a corresponding one of the ports; and
monitoring the amplitude changes to detect an erroneous optical fiber connection associated with the optical transmitters based on whether the respective amplitude changes contain the frequencies corresponding to the ports.
